(19) United States
(12) Patent Application Publication
(10) Pub. No.: US 2009/0128524 A1
(43) Pub. Date: May 21, 2009

(54) DISPLAY DEVICE CONTROL SYSTEMS AND METHODS

(75) Inventors: Jenn-Shoou Young, Hsinchu (TW); Sheng-Yuan Hoang, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsinchu (TW)

(21) Appl. No.: 12/250,000

(22) Filed: Oct. 13, 2008

(30) Foreign Application Priority Data
Nov. 15, 2007 (TW) 96143181

(51) Int. Cl. G09G 5/00

(52) U.S. Cl. 345/204

(57) ABSTRACT

Display device control systems and methods are provided. The system includes at least a first display device and a control device wirelessly coupled to the first display device. The first display device has a first identification. The control device includes an input unit. The control device generates a second identification via the input unit, and wirelessly transmits the second identification to the first display device. The first display device determines whether the second identification conforms to the first identification, and if so, accepts the control from the control device.

### CROSS REFERENCE TO RELATED APPLICATIONS

This Application claims priority of Taiwan Patent Application No. 096143181, filed on Nov. 15, 2007, the entirety of which is incorporated by reference herein.

### BACKGROUND OF THE INVENTION

1. Field of the Invention

The disclosure relates generally to display device control systems and methods, and, more particularly to systems and methods that independently control respective display devices on a video wall via a wireless device.

2. Description of the Related Art

Usually a video wall is composed of several display devices, such as monitors. Generally, the control of the video wall is performed by a remote computer host. The computer host transmits commands via an interface, such as a local area network or an RS 232 interface to the video wall, thus to control display devices on the video wall. Since the presentation results of the display devices cannot be definitely known from the remote computer host, a remote control directly pointing to and controlling the display devices on the video wall is required.

Generally, the remote control of the video wall controls all of the display devices simultaneously. That is, when the remote control generates and transmits a command, all of the display devices receive the command, and perform related adjustments according to the command. However, in some situations, since the shooting angle of the remote control cannot point to all of the display devices, parts of the display devices may not receive the command from the remote control. Thus, the display devices not receiving the command need to be individually controlled. Additionally, respective display devices on the video wall may need to be individually controlled and adjusted, since the display configurations and display results of the respective display devices on the video wall may not be uniform. For example, the brightness and contrast of the respective display devices may be different, thus for, such that the display results of the respective display devices on the video wall to be uniform, the respective display devices need to be individually controlled and adjusted. However, conventionally, when the remote control attempts to control an individual display device, the other display devices within the signal transmitting coverage of the remote control are also controlled. Therefore, the remote control may fail to control the display devices on the video wall individually.

Further, the pictures displayed by the respective display devices need to be arranged by the source (the image signal input to the video wall). For example, an entire image is divided, and the divided images are respectively transmitted to the respective display devices for display. Thus, the arrangement of the source requires user intervention and is time-consuming. Additionally, for an added representation effect, the source need to be arranged once, that is time-consuming and inefficient. Moreover, as described, the video wall is composed of several display devices and each display device consumes a predefined amount of power. When all of the display devices simultaneously power on, the required power consumption at a time is very large. Therefore, an appropriate power supply circuit may be designed according to the number of the display devices on the video wall. However, in some situations, when the display devices of the video wall are expanded, another power supply circuit may be again designed, making the expansion inconvenient and inefficient.

### BRIEF SUMMARY OF THE INVENTION

Display device control systems and methods are provided.

An objective of the invention is to provide systems and methods that independently control respective display devices on a video wall via a wireless device.

Another objective of the invention is to provide systems and methods that dynamically display specific parts of an image in the respective display devices on the video wall.

Further, another objective of the invention is to provide systems and methods that delay the power on timing of the respective display devices on the video wall.

An embodiment of a display device control system includes at least a first display device and a control device wirelessly coupled to the first display device. The first display device has a first identification. The control device includes an input unit. The control device generates a second identification via the input unit, and wirelessly transmits the second identification to the first display device. The first display device determines whether the second identification matches with the first identification, and if so, accepts the control from the control device.

An embodiment of a display device control system further includes a video source to transmit a signal including at least one picture to the first display device. The picture includes a first specific picture portion, and the first display device has a position setting, and selects and displays the first specific picture portion from the signal according to the position setting.

An embodiment of a display device control system further includes a host to transmit the first identification and a third command to the first display device when the first display device displays the first specific picture portion, such that the first display device resets the position setting. The picture further includes a second specific picture portion, and the first display device selects and displays the second specific picture portion from the signal according to the reset position setting.

An embodiment of a display device control system further includes a third display device having a delay setting with a predefined time interval. After the first display device powers on, the first display device transmits a power-on signal to the third display device, the third display device powers on in response to the power-on signal after the predefined time interval has passed.

In an embodiment of a display device control method, a second identification is generated via an input unit of a control device. The second identification is wirelessly transmitted to a first display device having a first identification from the control device. The first display device determines whether the second identification matches with the first identification, and if so, accepts the control from the control device.

In an embodiment of a display device control method, a video source further transmits a signal including at least one picture to the first display device, wherein the picture includes a first specific picture portion. The first display device selects and displays the first specific picture portion from the signal according to a position setting.

In an embodiment of a display device control method, a host further transmits the first identification and a third command to the first display device when the first display device displays the first specific picture portion. The first display device resets the position setting in response to the third command. The first display device further selects and displays a second specific picture portion from the signal according to the reset position setting, wherein the picture further includes the second specific picture portion.

In an embodiment of a display device control method, the first display device further transmits a power-on signal to a third display device having a delay setting with a predefined time interval after the first display device powers on. The third display device powers on in response to the power-on signal after the predefined time interval has passed.

Display device control systems and methods may take the form of a program code embodied in a tangible media. When the program code is loaded into and executed by a machine, the machine becomes an apparatus for practicing the disclosed method.

Other objectives, features and advantages of the present invention will be further understood from technological features disclosed by the embodiments of the present invention. Wherein the shown and described preferred embodiments of this invention, are simply illustrations of modes best suited to carry out the invention.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a display device control system of the invention;

FIG. 2 is a schematic diagram illustrating an embodiment of an example of connections among the display devices of the invention;

FIG. 3 is a schematic diagram illustrating an embodiment of a display device control system of the invention;

FIG. 4 is a flowchart of an embodiment of a display device control method of the invention;

FIG. 5 is a flowchart of an embodiment of a command execution method for a display device of the invention;

FIG. 6 is a flowchart of an embodiment of an identification reset method of the invention;

FIG. 7 is a flowchart of an embodiment of a dynamic display method for a display device of the invention; and

FIG. 8 is a flowchart of an embodiment of a delay power-on method of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

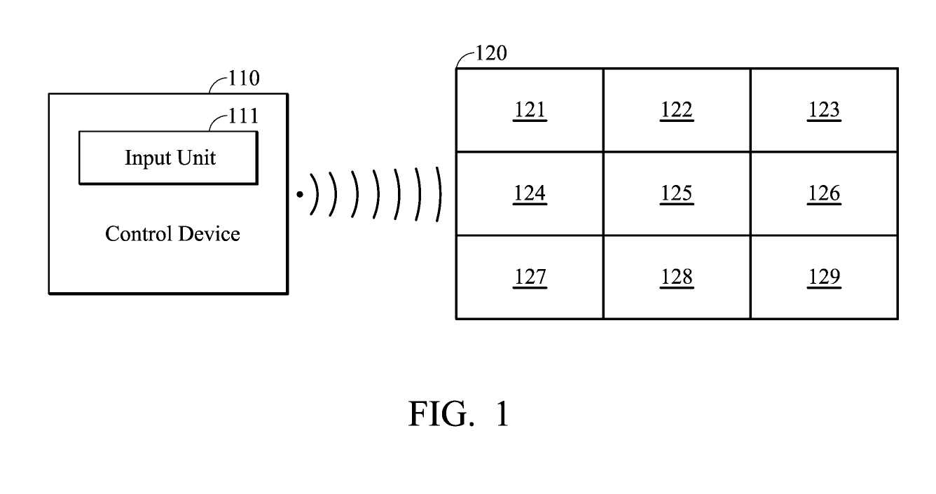

FIG. 1 is a schematic diagram illustrating an embodiment of a display device control system of the invention.

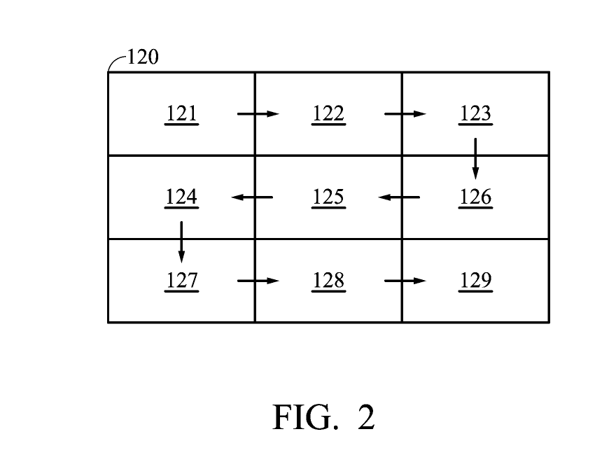

The display device control system includes a control device 110 and a combination of display devices 120. The control device 110 may be a remote control including an input unit 111. The input unit 111 is composed of a plurality of numeral, letter, and/or specific function keys, and generates identifications corresponding to the display devices and commands requesting the display devices to perform. The control device 110 wirelessly transmits signals to the display devices via a wireless module (not shown), such as infrared radiation (IR), blue tooth, and wireless fidelity (WiFi) modules. The combination of display devices 120 includes a plurality of display devices. In this embodiment, the combination of display devices 120 includes 9 display devices 121˜129. Each display device may have an identification and related display function settings, such as a divider setting, a position setting, a display mode setting, and an aspect ratio setting. Additionally, each of the display devices may have a delay setting, wherein a more detailed description is discussed later. In some embodiments, the combination of display devices 120 may be a video wall. In some embodiments, the display devices in the combination of display devices 120 are connected in series, as the arrows show in FIG. 2. It is understood that, in some embodiments, the display devices may be respectively independent, and do not form a video wall.

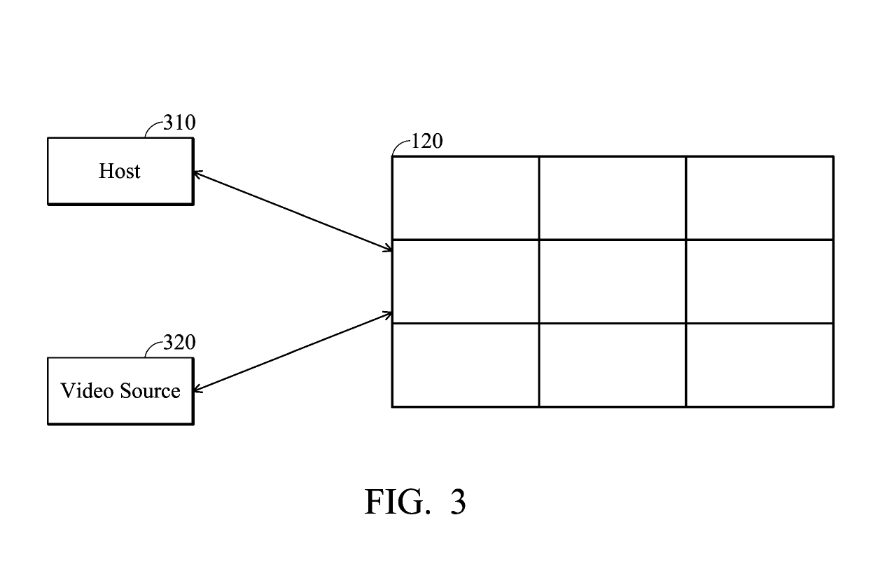

FIG. 3 is a schematic diagram illustrating an embodiment of a display device control system of the invention. In this embodiment, a host 310 and a video source 320 respectively couple to the combination of display devices 120. The host 310 may obtain the identifications and display function settings of the respective display devices via a wireless or wired interface. The host 310 may also transmit commands to the respective display devices via the wireless or wired interface, such that the respective display devices may reset the corresponding identifications and display function settings. In some embodiments, the host 310 may be the control device 110 as shown in FIG. 1. The video source 320 transmits signals to the display devices for display. It is noted that, in some embodiments, the signals transmitted by the video source 320 to the display devices include at least one picture (frame). The respective display device selects and displays a specific picture portion from the received signal according to its corresponding position setting.

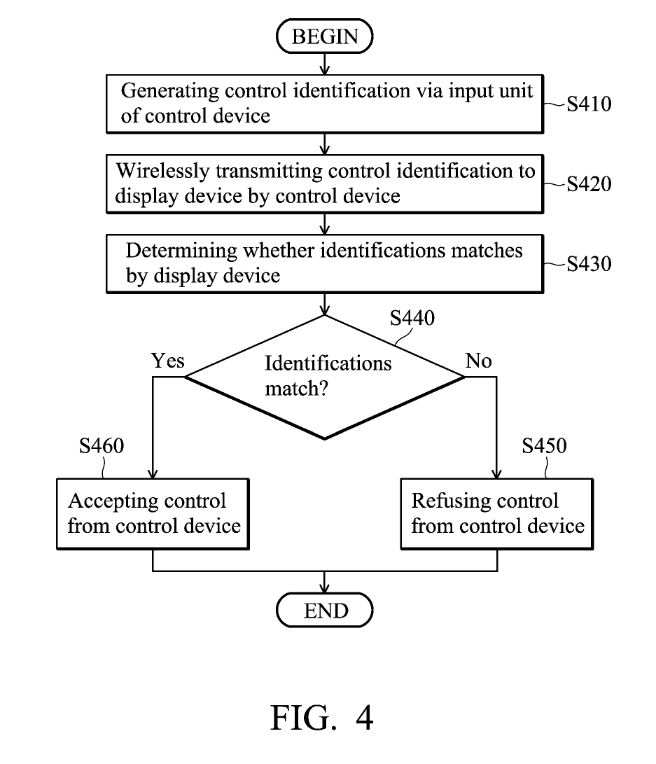

FIG. 4 is a flowchart of an embodiment of a display device control method of the invention.

In step S410, a control identification is generated via the input unit of the control device, and in step S420, the control device wirelessly transmits the control identification to a display device. The display device has a preset device identification. In step S430, the display device determines whether the control identification received from the control device matches with the preset device identification. If the two identifications do not match (No in step S440), in step S450, the display device refuses the control of the control device. If the two identifications match (Yes in step S440), in step S460, then the display device accepts the control from the control device.

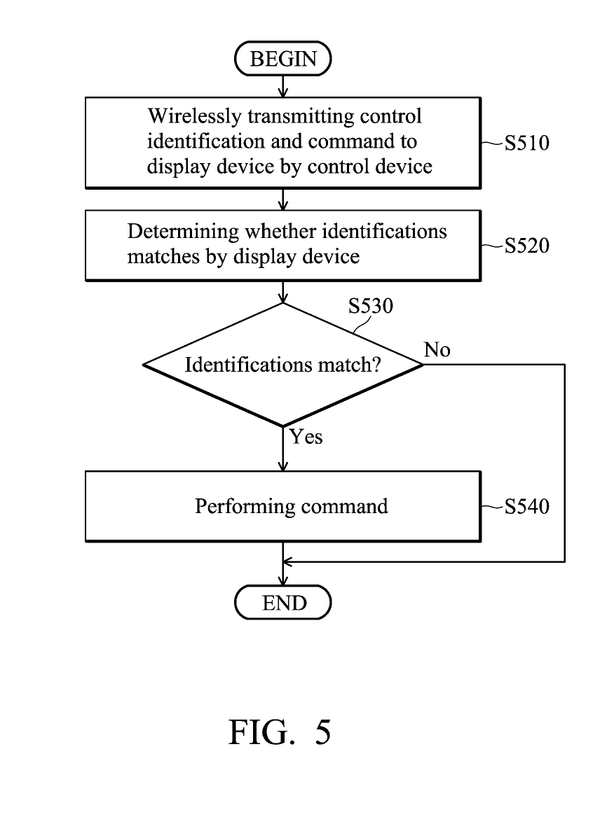

FIG. 5 is a flowchart of an embodiment of a command execution method for a display device of the invention.

In step S510, a control identification and a command are generated via the input unit of the control device, and are wirelessly transmitted to a display device. Similarly, the display device has a preset device identification. In step S520, the display device determines whether the control identification received from the control device matches with the preset device identification. If the two identifications do not match (No in step S530), the procedure is completed. If the two identifications match (Yes in step S530), in step S540, the display device performs the command received from the control device. It is understood that, the command may set or update the identification and/or the display function settings of the display device.

In some embodiments, the command may be a reset command directing the display device to cancel the preset device identification. It is understood that, in some embodiments, the reset command is performed when the two identifications match. However, in some embodiments, the display device does not perform the identification determination, but directly performs the reset command to cancel the preset device identification. All display devices receiving the reset command will cancel the corresponding preset device identifications. In the above embodiments, the control device may transmit the reset command to the respective display device, or to several display devices simultaneously. When a display device cancels the preset device identification, the step of identification determination will not be performed. That is, all display devices may perform a command if they receive the command.

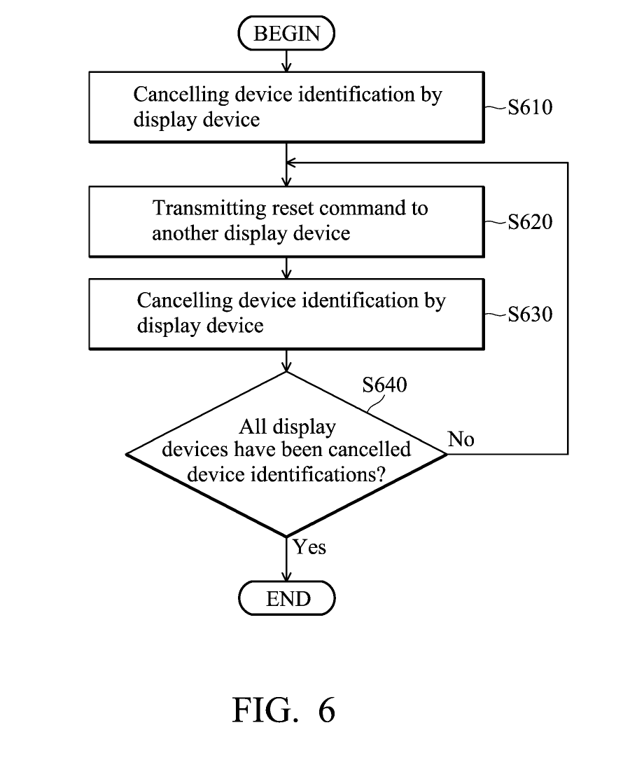

FIG. 6 is a flowchart of an embodiment of an identification reset method of the invention. In this embodiment, a display device receiving a reset command forwards the reset command to other display devices.

When a display device receives a reset command, in step S610, the display device cancels the preset device identification. In step S620, the display device transmits the reset command to another display device. In step S630, the display device receiving the reset command cancels its preset device identification in response to the reset command. Then, in step S640, it is determined whether all display devices have cancelled the corresponding preset device identifications. If so (Yes in step S640), the procedure is completed. If not (No in step S640), the procedure returns to step S620, wherein the display device continues to transmit the reset command to another display device.

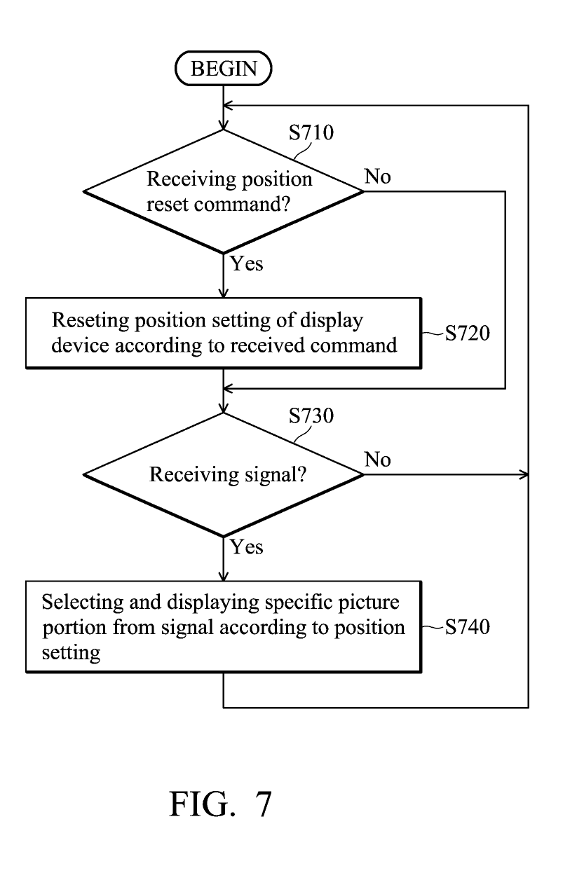

As described, the respective display device may have the position setting, and may select and display a specific picture portion from the received signal according to the position setting. FIG. 7 is a flowchart of an embodiment of a dynamic display method for a display device of the invention.

In step S710, it is determined whether a position reset command is received from the host or the control device. If no position reset command is received (No in step S710), the procedure goes to step S730. If the position reset command is received (Yes in step S710), in step S720, the display device resets the position setting according to the received reset position command. Then, in step S730, it is determined whether at least one signal is received from the video source. If no signal is received (No in step S730), the procedure returns to step S710. If the signal is received (Yes in step S730), in step S740, the display device selects and displays a specific picture portion from the received signal according to the position setting. Then, the procedure returns to step S710.

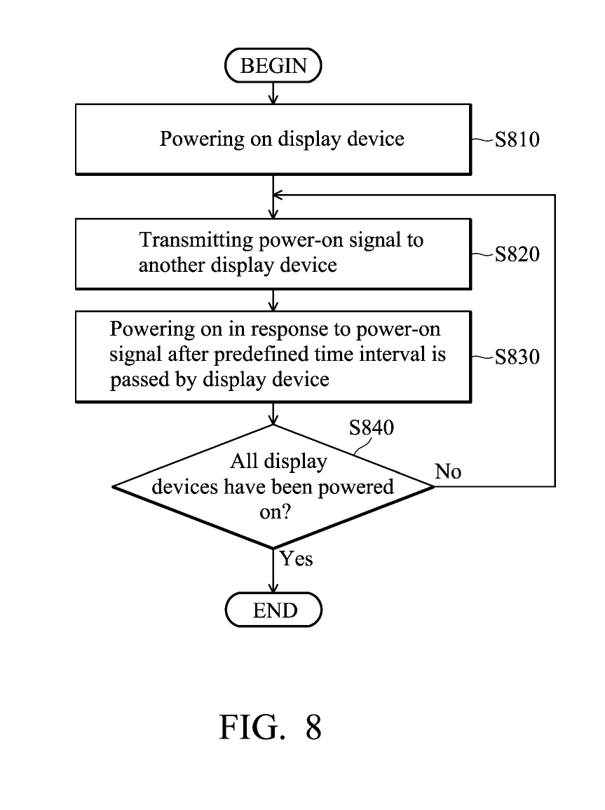

FIG. 8 is a flowchart of an embodiment of a delay power-on method of the invention.

In step S810, a display device powers on. After the display device powers on, in step S820, the display device transmits a power-on signal to another display device. In step S830, the display device powers on in response to the power-on signal after a predefined time interval of its delay setting has passed. Then, in step S840, it is determined whether all display devices have been powered on. If so (Yes in step S840), the procedure is completed. If not (No in step S840), the procedure returns to step S820, wherein the display device continues to transmit the power-on signal to another display device.

Therefore, the display device control systems and methods of the embodiments independently control respective display devices on a video wall via a wireless device. Additionally, specific parts of an image may be dynamically displayed in the respective display devices on the video wall. Further, the power on timings of the respective display devices on the video wall may be delayed.

Display device control methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display device control system, comprising:
a first display device having a first identification; and
a control device wirelessly coupled to the first display device, comprising an input unit, generating a second identification via the input unit, and wirelessly transmitting the second identification to the first display device,
wherein the first display device determines whether the second identification matches with the first identification, and if so, accepts the control from the control device.

2. The system of claim 1, wherein the control device further wirelessly transmits a first command to the first display device, and the first display device performs the first command when the first identification and the second identification match.

3. The system of claim 2, wherein the first command is used to set or update the first identification of the first display device.

4. The system of claim 2, wherein the first command is used to set or update a display function setting of the first display device, wherein the display function setting comprises a picture divider setting, a position setting, a display mode setting, or an aspect ratio setting.

5. The system of claim 1, wherein the control device further wirelessly transmits a reset command to the first display device, and the first display device performs the reset command to cancel the first identification.

6. The system of claim 5, wherein when the first identification is cancelled, the control device further wirelessly transmits a second command to the first display device, and the first display device performs the second command.

7. The system of claim 5, further comprising a second display device, wherein the first display device further transmits the reset command to the second display device, and the second display device performs the reset command to cancel a third identification of the second display device.

8. The system of claim 1, further comprising a video source to transmit a signal comprising at least one picture to the first display device, wherein the picture comprises a first specific picture portion, and the first display device selects and displays the first specific picture portion from the signal according to a position setting of the first display device.

9. The system of claim 8, further comprising a host to transmit the first identification and a third command to the first display device when the first display device displays the first specific picture portion, such that the first display device resets the position setting, and selects and displays a second specific picture portion from the signal according to the reset position setting.

10. The system of claim 1, further comprising a third display device having a delay setting with a predefined time interval, wherein after the first display device is powered on, the first display device transmits a power-on signal to the third display device, and the third display device powers on in response to the power-on signal after the predefined time interval has passed.

11. A display device control method, comprising:
generating a second identification via an input unit of a control device;
wirelessly transmitting the second identification to a first display device having a first identification from the control device;
determining whether the second identification matches with the first identification by the first display device; and
if the second identification matches with the first identification, accepting the control from the control device by the first display device.

12. The method of claim 11, further comprising:
wirelessly transmitting a first command to the first display device by the control device; and
performing the first command by the first display device when the first identification and the second identification match.

13. The method of claim 12, wherein the first command is used to set or update the first identification of the first display device.

14. The method of claim 12, wherein the first command is used to set or update a display function setting of the first display device, wherein the display function setting comprises a picture divider setting, a position setting, a display mode setting, or an aspect ratio setting.

15. The method of claim 11, further comprising:
wirelessly transmitting a reset command to the first display device by the control device; and
performing the reset command to cancel the first identification by the first display device.

16. The method of claim 15, wherein when the first identification is cancelled, the method further comprises the steps of:
wirelessly transmitting a second command to the first display device by the control device; and
performing the second command by the first display device.

17. The method of claim 15, further comprising;
transmitting the reset command to a second display device by the first display device; and
performing the reset command to cancel a third identification of the second display device by the second display device.

18. The method of claim 11, further comprising:
transmitting a signal comprising at least one picture to the first display device by a video source, wherein the picture comprises a first specific picture portion; and
selecting and displaying the first specific picture portion from the signal according to a position setting of the first display device by the first display device.

19. The method of claim 18, further comprising:
transmitting the first identification and a third command to the first display device by a host when the first display device displays the first specific picture portion, such that the first display device resets the position setting; and
selecting and displaying a second specific picture portion from the signal according to the reset position setting by the first display device.

20. The method of claim 11, further comprising:
after the first display device is powered on, transmitting a power-on signal to a third display device by the first display device, wherein the third display device has a delay setting with a predefined time interval; and
powering on the third display device in response to the power-on signal after the predefined time interval has passed.
